(19) United States
(12) Patent Application Publication
(10) Pub. No.: US 2004/0091675 A1
(43) Pub. Date: May 13, 2004

(54) Tension-type buffering device

(76) Inventor: Teng-Jen Yang, Taichung Hsien (TW)

Correspondence Address: Hart, Baxley, Daniels & Holton, 59 John Street, Fifth Floor, New York, NY, 10038, US

(21) Appl. No.: 10/305,906

(22) Filed: Jan. 27, 2003

(30) Foreign Application Priority Data
Nov. 7, 2002 (TW) 091217854

(51) Int. Cl. B32B 1/00

(52) U.S. Cl. 428/174

(57) ABSTRACT

A tension-type buffering device includes a flexible plastic member and a stiff plastic member which is connected to the flexible plastic member by way of gluing, plastic injection, or fusion. The wave-shaped strips of the stiff plastic member are alternatively connected to the flexible plastic member and a plurality of semi-circular compression spaces are defined between the wave-shaped strips and the tension strips of the flexible plastic member. The compression spaces are squeezed when the wave-shaped strips are compressed and go back to their original size after the force of compression is released. The device can be used as a shoe sole, a knee protector or a mattress.

### FIELD OF THE INVENTION

The present invention relates to a tension-type buffering device and especially to a buffering device made of plastic material.

### BACKGROUND OF THE INVENTION

Buffering device is installed in the sole of sport shoes so as to reduce impact to the wearer's feet. However, the space that receives the buffering device is limited so that the cost of installation of the buffering device is high. Another buffering device is used to be put in a box and can be sheets or sponges. The buffering device cannot be put in the box evenly so that the contents in the box still has the risk of being broken when the box hits objects.

### SUMMARY OF THE INVENTION

The present invention intends to provide a tension-type buffering device that includes a flexible plastic member and a stiff plastic member including wave-shaped strips which are engaged with the plastic member so as to define multiple spaces which can be squeezed when applied by forces and pop up after the force is released. The buffering device can be used in different fields such as in shoe soles, knee protectors or mattresses.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a first embodiment of the device of the present invention;

FIG. 2 is a perspective view to show the device of the first embodiment of the present invention;

FIG. 3 is a cross sectional view to show the first embodiment of the device of the present invention;

FIG. 4 is another cross sectional view to show the first embodiment of the device of the present invention;

FIG. 5 is a cross sectional view to show that the first embodiment of the device of the present invention is compressed;

FIG. 6 is another cross sectional view to show the first embodiment of the device of the present invention;

FIG. 7 is a cross sectional view to show the second embodiment of the device of the present invention;

FIG. 8 is a cross sectional view to show the third embodiment of the device of the present invention;

FIG. 9 is a cross sectional view to show the fourth embodiment of the device of the present invention;

FIG. 10 is a cross sectional view to show the fifth embodiment of the device of the present invention; and

FIG. 11 shows that the tension strips have holes for the wave-shaped strips extending therethrough.

### DETAILED DESCRIPTION OF THE PREFERRED EMBODIMENT

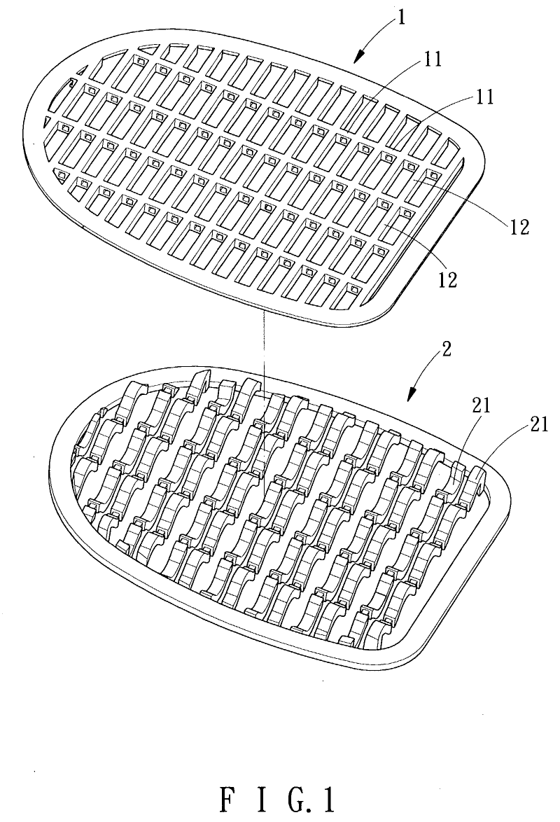

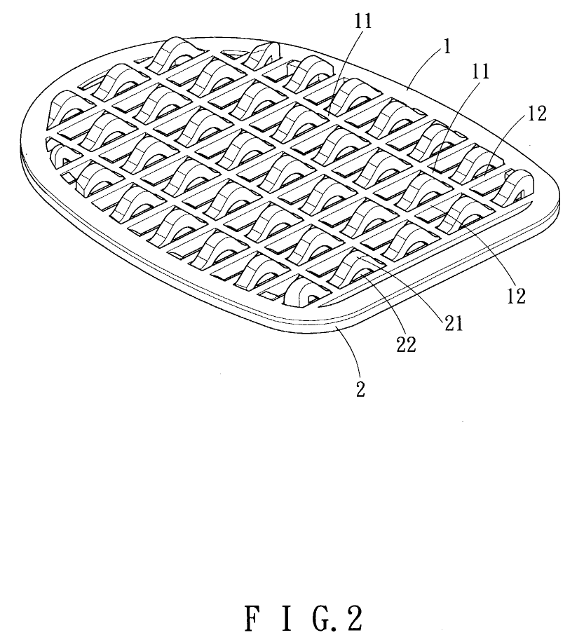

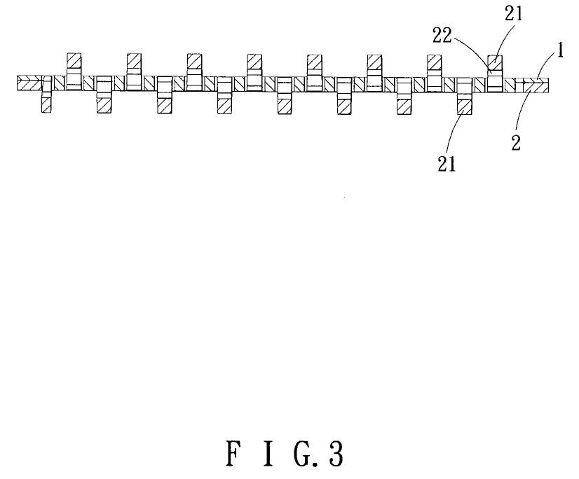

Referring to FIGS. 1 to 4, the tension-type buffering device of the present invention comprises a flexible plastic member 1 and a stiff plastic member 2. The flexible plastic member 1 is made by flexible plastic material and includes a plurality of tension strips 11 and gaps are defined between the strips 11. A plurality of reinforcement strips 12 are alternatively engaged with the tension strips 11 and as a one-piece.

The stiff plastic member 2 is made of stiff plastic material and includes a plurality of wave-shaped strips 21 and each of which is in an S-shaped form with gaps defined between the wave-shaped strips 21. The wave crests of any two adjacent wave-shaped strips 21 are located alternatively such that the wave crests on the even numbered row and the wave crests on the odd numbered rows are alternatively located.

The flexible plastic member 1 and the stiff plastic member 2 are engaged with each other by way of gluing, plastic injection, or fusion. The two plastic members 1 and 2 may also be made individually and then combined with each other. The wave-shaped strips 21 and the tension strips 11 can be alternatively combined as a one-piece and a semi-circular compression spaces 22 are defined between the wave-shaped strips 21 and the tension strips 11. The compression spaces 22 are squeezed when the wave-shaped strips are compressed and go back to their original size after the force of compression is released.

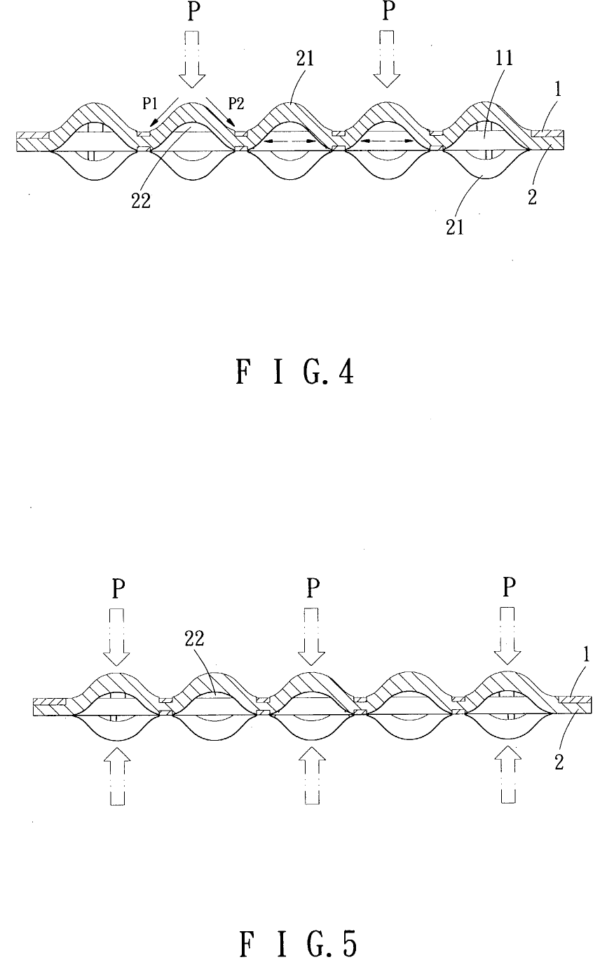

Referring to FIGS. 4 and 5, when the stiff plastic member 2 is compressed by a force as shown by the dotted arrow head “P”, the wave-shaped strips 21 are pressed downward and the force “P” is separated into two sub-forces “P1” and “P2”. The tension-type strips 11 are pulled at the two sides thereof as shown by the solid arrow head line because they are integrally connected to the wave-shaped strips 21 and this buffers the compression force. The stiff plastic members 2 at the other direction also absorb some compression force so that the compression spaces 22 become smaller.

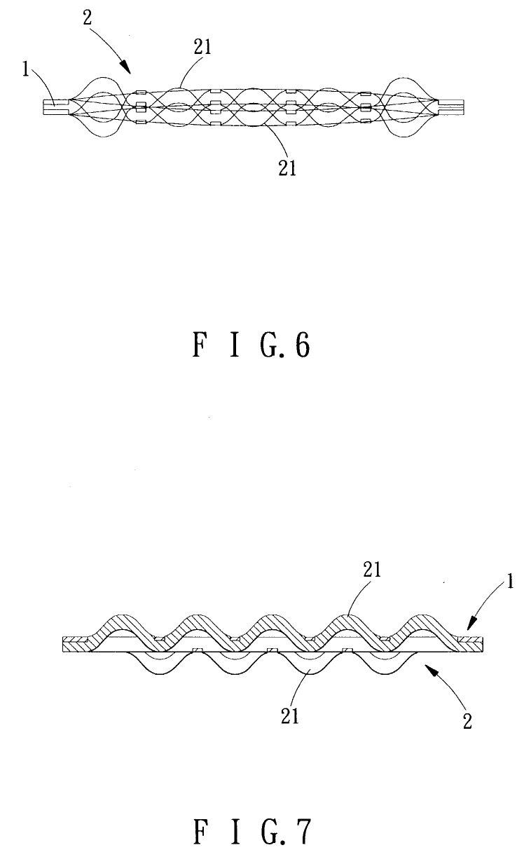

Due to the nature of the flexible plastic member 1 and the wave-shaped strips 21 the stiff plastic member 2, after the “P” is released, the stiff plastic member 2 returns to its original shape as shown in FIG. 5 and the flexible plastic member 1 returns to its original shape as shown in FIG. 6.

As shown in FIG. 7 which shows a second embodiment of the present invention, wherein the wave crests of the wave-shaped strips 21 are located in correspondence with each other so that the wave-shaped strips 21 have the same compressibility and the ability of returning to their original shape.

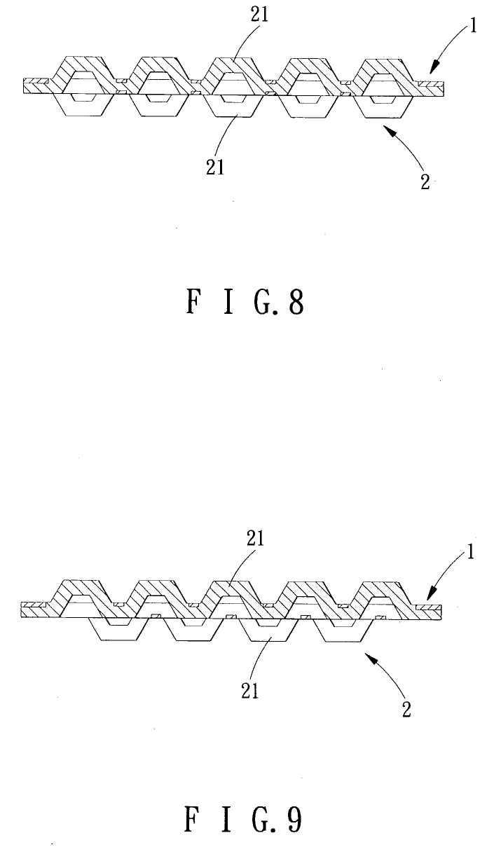

As shown in FIG. 8 which shows a third embodiment of the present invention, wherein the strips 21 each have a trapezium-shaped wave. The trapezium-shaped waves of any two adjacent shaped strips 21 are located alternatively such that the trapezium-shaped waves on the even numbered row and the trapezium-shaped waves on the odd numbered rows are alternatively located. As shown in FIG. 9 which shows a fourth embodiment of the present invention wherein the trapezium-shaped waves of the strips 21 are located in correspondence with each other.

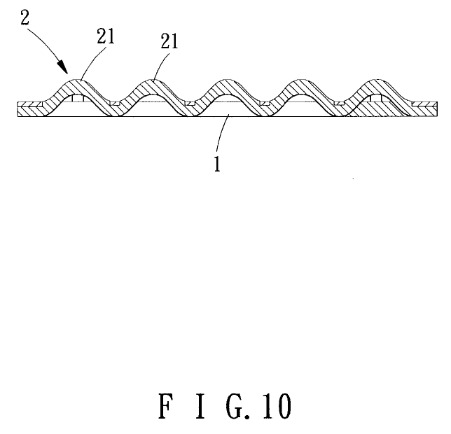

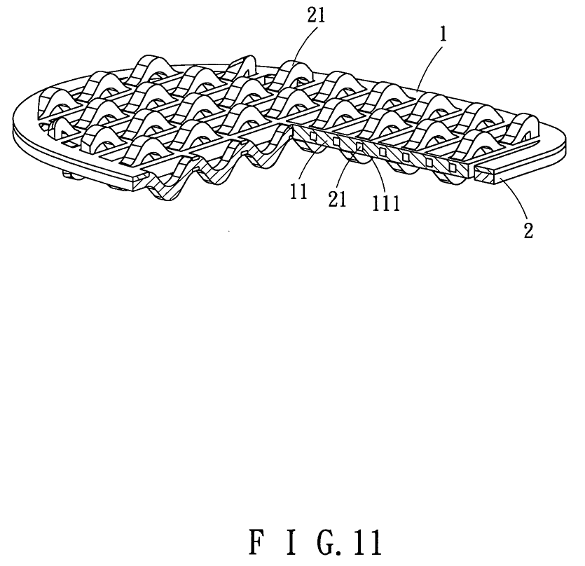

As shown in FIG. 10 which shows a fifth embodiment of the present invention wherein the height of the wave crests in any two adjacent rows of the wave-shaped strips 21 has a certain amount of difference and the wave crests of the wave-shaped strips 21 are located in correspondence with each other.

A shown in FIG. 11, each of the tension strips 11 of the flexible plastic member 1 has a hole 111 through which the wave-shaped strips 21 extend so as to combine the tension strips 11 and the wave-shaped strips 21 together. This prevents the tension strips 11 or the wave-shaped strips 21 from being broken when they are compressed.

The flexible plastic member 1 and the stiff plastic member 2 are combined and made into a shoe sole to protect the wearers from being injured. The combination is also able to be used as a knee, elbow, or any joint protection. The combination can be used as an inner layer to buffer impact to boxes or as a mattress, a chair pad.

While we have shown and described the embodiment in accordance with the present invention, it should be clear to those skilled in the art that further embodiments may be made without departing from the scope of the present invention.

What is claimed is:

1. A tension-type buffering device comprising:
a flexible plastic member;
a stiff plastic member having a plurality of wave-shaped strips and connected to the flexible plastic member in an alternative fashion so as to define compression spaces between the wave-shaped strips and the flexible plastic member, the compression space being squeezed when the wave-shaped strips are compressed and the compression space return to their original size after the wave-shaped strips are not compressed.

2. The device as claimed in claim 1, wherein the flexible plastic member includes a plurality of tension strips which are alternatively engaged with the wave-shaped strips, a plurality of reinforcement strips alternatively connected to the tension strips.

3. The device as claimed in claim 1, wherein the tension strips each have a hole through which the wave-shaped strips extend so that the wave-shaped strips are enclosed by the tension strips.

4. The device as claimed in claim 1, wherein the wave-shaped strips are S-shaped.

5. The device as claimed in claim 1, wherein the wave-shaped strips are trapezium-shaped.

6. The device as claimed in claim 1, wherein a height of wave crests in any two adjacent rows of the wave-shaped strips has a certain amount of difference and the wave crests of the wave-shaped strips are located alternatively.

7. The device as claimed in claim 1, wherein a height of wave crests in any two adjacent rows of the wave-shaped strips has a certain amount of difference and the wave crests of the wave-shaped strips are located in correspondence with each other.

8. The device as claimed in claim 1, wherein wave crests in any two adjacent rows of the wave-shaped strips have the same height and the wave crests of the wave-shaped strips are located alternatively.

9. The device as claimed in claim 1, wherein wave crests in any two adjacent rows of the wave-shaped strips have the same height and the wave crests of the wave-shaped strips are located in correspondence with each other.

10. The device as claimed in claim 1, further comprising a plurality of reinforcement strips alternatively connected to the tension strips.
